(19) United States
(12) Patent Application Publication
(10) Pub. No.: US 2006/0204663 A1
(43) Pub. Date: Sep. 14, 2006

(54) Method, and apparatus for producing recording sheet

(75) Inventors: Kazuhiko Nojo, Fujinomiya-shi (JP); Shuichi Endo, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/370,999

(22) Filed: Mar. 9, 2006

(30) Foreign Application Priority Data
Mar. 11, 2005 (JP) 2005-069880

(51) Int. Cl. B05D 3/12; B05C 3/02

(52) U.S. Cl. 427/356; 427/402; 118/413; 118/414

(57) ABSTRACT

The present invention provides A method for producing a recording sheet including the steps of coating and forming a coloring material receiving layer containing inorganic particulates and a water-soluble resin on a band-shaped substrate which is wound and supported on a backup roller and continuously travels, and thereafter, coating and forming a top layer on the coloring material receiving layer in a semidry state, comprising: coating the top layer by an extrusion type coater which coats a coating solution to the surface of the substrate via a bead which is formed between the lip tip end and the substrate with cross-linking the coating solution discharged from a lip tip end of a coating head the surface of the substrate, in a state of pressure of an upstream side of the bead reduced so that a pressure reduction degree with respect to atmospheric pressure is in a range from over 0 kPa to 2.0 kPa by providing a suction chamber at an upstream side of the coating head seen in a traveling direction of the substrate.

### BACKGROUND OF THE INVENTION

1. Field of the Invention

The present invention relates to a method and an apparatus for producing a recording sheet, and particularly relates to a technique of coating a top layer on an occasion of coating the top layer on a coloring material receiving layer containing inorganic particulates and a water-soluble resin on a substrate in a semidry state of the coloring material receiving layer, such as a high quality ink jet recording sheet.

2. Description of the Related Art

Various types of ink jet methods have been developed to date, and with their development, various types of ink jet recording sheets have also been developed. Substrates used in these ink jet recording sheets include not only a variety of resin films but also plain paper, wood free paper (coat paper), photographic paper and the like. Of these ink jet recording sheets, those provided with a coloring material receiving layer which contains inorganic particulates of fine diameter and a water-soluble resin are now in use as high quality ink jet recording sheets. The recording sheets provided with a coloring material receiving layer containing inorganic particulates and a water-soluble resin also include those for thermal transfer recording, for electrophotography and the like.

As the method for producing a recording sheet provided with a coloring material receiving layer containing inorganic particulates and a water-soluble resin, the present applicant proposed a manufacturing method and apparatus disclosed in Japanese Patent Application Laid-open No. 2001-113820. The method and apparatus excessively coat a top layer such as a crosslinking agent on a coloring material receiving layer in a semidry state after coating and forming the coloring material receiving layer containing inorganic particulates and a water-soluble resin on a substrate. Namely, the top layer is excessively coated on the coloring material receiving layer by wet on wet method so as not to damage the coloring material receiving layer which still has flowability. Then, within 30 seconds after the top layer is coated and formed, a smoothing/metering treatment is performed with a unit with a bar, a blade, an air knife or the like to perform smoothing of the top layer film surface and coating amount adjustment of the top layer. For the coating method of the top layer, a curtain coater, a bar coater, a roll coater, a slide bead coater, an extrusion coater and the like can be used.

The reason of adjusting the final top layer coating amount (hereinafter called “required coating amount”) by the smoothing/metering treatment after the top layer is excessively coated is as follows. The surface condition of the film surface of the coloring member receiving layer which is a sublayer is bad because it contains the inorganic particulates, and when a required coating amount of top layer is coated thereon, the surface condition of the top layer also becomes bad especially when the top layer is a thin film. From this, in order to coat the top layer stably, more excessive amount of top layer than the required coating amount is coated, and thereafter, the amount of the top layer is adjusted to the required coating amount by the smoothing/metering treatment. Hereinafter, the amount of the coating solution which is supplied from a coating head to be coated as the top layer is called “supply coating amount”.

### SUMMARY OF THE INVENTION

However, when a curtain coater is used as a coating device for coating the top layer in the method for producing a recording sheet in Japanese Patent Application Laid-open No. 2001-113820, an increase in the coating speed (traveling speed of the substrate) causes the problem that the curtain film of the coating solution to be strongly drawn in the traveling direction of the substrate and disturbed by the entrained wind occurring due to the travel of the substrate, and the curtain film is cut. As the countermeasures, it is conceivable to increase the supply coating amount of the top layer excessively (for example, the film flow rate of 1.0 cc/cm/sec or more) and makes the curtain film thick and difficult to cut. However, if the curtain film is formed with the supply coating amount made extremely excessive with respect to the required coating amount, the scraped amount which is scraped in the smoothing/metering treatment after coating is large, and this causes the disadvantage that the coating solution loss easily occurs. For example, when the required coating amount is 50 cc/m², if coating is to be performed at the coating speed of 20 m/min, coating has to be conducted with the supply coating amount which is five times as large as the required coating amount, the scraped amount by the smoothing/metering treatment is extremely large, which causes the coating solution loss and the like. In this case, the scraped amount decreases by performing coating at the coating speed of 100 m/min, but the curtain film is not stable and stable coating cannot be performed.

With a bar coater or a roll coater, the coating solution scraped up with a bar or a roll is coated on the substrate with a clearance of not more than 2 mm as in Japanese Patent Application Laid-open No. 2001-113820 in such a manner as not to damage the coloring material receiving layer with flowability, and when the coating speed is increased, a so-called lack of solution phenomenon in which the coating solution is not coated on the substrate occurs. As the countermeasures against this, there is the method for increasing the rotational speed of the bar or the roll by decreasing the clearance, but in order to achieve the coating speed of 20 m/min or more, the clearance has to be made 0.2 mm or less, the risk of the bar or the roll coming in contact with the coloring material receiving layer in the semidry state becomes high, and production stability becomes extremely low. Further, when the rotational speed of the bar or the roll is increased, there is the problem that scattering of the coating solution becomes large at the bar end portion or the roll end portion. In order to increase the scraped amount of the coating solution in the case of using the bar or the roll, it is possible to handle it by increasing the thickness of the wire which is wound around the bar, or engraving applied to the roll surface, but as in the case of the curtain coater, there is the problem that the scraped amount in the smoothing/metering treatment becomes large after coating.

The method for coating the substrate with the coating solution via a bead (coating solution accumulation) as a slide coater and an extrusion coater easily increases a coating speed as compared with a curtain coater or a roll coater, but when the coating speed is to be increased to 20 m/min or more in the conventional standard slide coaters and extrusion coaters under the special conditions in which the top layer is coated and formed on a coloring material receiving layer in a semidry condition, the problem that the bead is used up in the top layer coating and imperfect coating occurs is caused. If imperfect coating caused by using up the bead occurs, the coating thickness distribution becomes large, and cannot be decreased even if the subsequent smoothing/metering treatment and the coating solution prescription of the top layer are changed.

As described above, with the conventional method for producing a recording sheet of Japanese Patent Application Laid-open No. 2001-113820, the coating speed is limited to 20 m/min even when any coating method is adopted for coating the top layer, and in order to increase the coating speed to be higher than this, there is no other choice but to adopt the method for stabilizing the bead by increasing the supply coating amount to not less than twice as large as the required coating amount, and scraping the large amount of coating solution in the subsequent smoothing/metering treatment. Though the scraped coating solution is recycled and reused, the number of process steps increases because the adjustment step for returning the components and physical properties of the coating solution to the original state and the filtering step for removing dust and impurities are needed for reuse, and large coating solution loss occurs by the coating solution passing through these steps.

The present invention is made in view of the above circumstances, and has an object to provide a method and an apparatus for producing a recording sheet which is capable of enhancing productivity by reducing coating solution loss even in high-speed coating because of being capable of performing stable coating even when coating speed is increased (20 m/min or more) in a state in which an excess amount of a supply coating amount with respect to a required coating amount is zero or as small as possible, and therefore, capable of causing no scraped amount or reducing the scraped amount, in coating the top layer on producing the recording sheet provided with a coloring material receiving layer containing inorganic particulates and a water soluble resin.

In order to achieve the above-described object, the present invention provides, in a method for producing a recording sheet including the steps of coating and forming a coloring material receiving layer containing inorganic particulates and a water-soluble resin on a band-shaped substrate which is wound and supported on a backup roller and continuously travels, and thereafter, coating and forming a top layer on the coloring material receiving layer in a semidry state, comprising: coating the top layer by an extrusion type coater which coats a coating solution to the surface of the substrate via a bead which is formed between the lip tip end and the substrate with cross-linking the coating solution discharged from a lip tip end of a coating head the surface of the substrate, in a state of pressure of an upstream side of the bead reduced so that a pressure reduction degree with respect to atmospheric pressure is in a range from over 0 kPa to 2.0 kPa by providing a suction chamber at an upstream side of the coating head seen in a traveling direction of the substrate.

According to a first aspect of the present invention, an extrusion type coater, which applies the coating solution for the top layer discharged from the lip tip end of the coating head onto the substrate via the bead, is used as a coater which coats and forms the top layer on the coloring material receiving layer in the semidry state, the suction chamber is provided at the upstream side of the coating head seen in the traveling direction of the substrate, and coating is conducted with the pressure of the upstream side of the bead reduced so that the pressure reduction degree with respect to the atmospheric pressure is in the range from over 0 kPa to 2.0 kPa.

Thereby, even the high-speed coating is conducted, a stable bead can be formed in the state in which the excess amount of the supply coating amount with respect to the required coating amount is small, and therefore, poor coating due to breaking of the bead does not occur even when the coating speed is increased to 20 m/min or more, which is the limit of the conventional coating speed. Since the scraped amount can be remarkably decreased as a result, the coating solution loss can be reduced and productivity can be enhanced.

When the pressure reduction degree of the suction chamber becomes larger than 2.0 kPa with respect to the atmospheric pressure, the bead is drawn so much that a line trouble is likely to occur to the film surface of the top layer. Accordingly, the pressure reduction degree is 2.0 kPa with respect to the atmospheric pressure, and the pressure reduction degree is more preferably 1.0 kPa or less with respect to the atmospheric pressure.

In the first aspect, a second aspect is such that a slit clearance of the coating head is set in a range from over 50 μm to 500 μm, and a thickness of a downstream side lip seen in the traveling direction of the substrate is set in a range from over 30 μm to 500 μm.

By setting a slit clearance of the coating head in a range from over 50 ; μm to 500 μm, and by setting a thickness of a downstream side lip seen in the traveling direction of the substrate is set in a range from over 30 μm to 500 μm, the bead can be more stabilized. Thereby, higher speed coating is enabled in the state in which the excess amount of the supply coating amount with respect to the required coating amount is small. The slit clearance is more preferably in the range from over 50 μm to 300 μm, and still more preferable in the range from 50 μm to 200 μm. The thickness of the downstream side lip is more preferably in the range from over 30 μm to 300 μm.

In the first or the second aspect, a third aspect is characterized in that a structure of the lip tip end of the coating head is made an overbite structure with an upstream side lip length smaller than a downstream side lip length, and an amount of the overbite is set in a range from over 0 μm to 500 μm.

By making a structure of the lip tip end the overbite structure and by making the upstream side lip length smaller than the downstream side lip length in the range from over 0 μm to 500 μm, the bead can be further stabilized. Thereby, higher speed coating is enabled in the state in which the excess amount of the supply coating amount with respect to the required coating amount is small.

In any one of the first to the third aspects, a fourth aspect is characterized in that a lip clearance between the upstream side lip and a surface of the coloring material receiving layer coated on the substrate is set in a range from over 50 μm to 500 μm.

By setting the lip clearance between the upstream side lip and the surface of the coloring material receiving layer coated on the substrate in the range from over 50 μm to 500 μm, the bead can be further stabilized. Thereby, higher speed coating is enabled in the state in which the excess amount of the supply coating amount with respect to the required coating amount is small. The lip clearance is more preferably in the range from over 50 μm to 300 μm, and still more preferably in the range from over 50 μm to 200 μm.

In any one of the first to the fourth aspects, a fifth aspect is characterized in that smoothing of a surface of the top layer film and adjustment of a coating amount of the top layer are performed by conducting smoothing/metering treatment within 30 seconds after the top layer is coated and formed.

The fifth aspect is the case where smoothing of the top layer surface and adjustment of the coating solution amount of the top layer are performed by conducting the smoothing/metering treatment after the supply coating amount is coated in excess with respect to the required coating amount, and the smoothing/metering treatment is preferably conducted within 30 seconds after the top layer is coated and formed. By the smoothing/metering treatment, deterioration of the surface conditions of the top layer film surface due to bad surface conditions of the coloring material receiving layer as the sublayer, bubble troubles and the like can be repaired, but after 30 seconds, the repairing effect is reduced.

In any one of the first to the fifth aspects, a sixth aspect is characterized in that the top layer is a crosslinking agent layer for hardening the coloring material receiving layer.

There are the case where as the top layer, another coloring material receiving layer is applied, the case where the overcoat layer such as a protection layer, a crosslinking agent layer or the like is applied and the like, but the present invention is more effective when the crosslinking agent layer which hardens the coloring material receiving layer is applied as the top layer.

In order to achieve the above described object, a seventh aspect provides, in an apparatus for producing a recording sheet for coating and forming a top layer on a coloring material receiving layer in a semidry state after coating and forming the coloring material receiving layer containing inorganic particulates and a water-soluble resin, on a band-shaped substrate which continuously travels, an apparatus for producing a recording sheet characterized by including a coater for a coloring material receiving layer which coats and forms the coloring material receiving layer on the substrate, a first dryer which dries the coloring material receiving layer to the semidry state, an extrusion type coater for the top layer which coats and forms the top layer on the coloring material receiving layer in the semidry state, and a second dryer which dries the top layer after the top layer is coated, and characterized in that the extrusion type coater for the top layer includes a coating head which coats a coating solution for the top layer discharged from a lip tip end onto the substrate via a bead, a backup roller which is disposed to be opposed to the coating head and supports the substrate, and a suction chamber which is provided at an upstream side of the coating head seen in a traveling direction of the substrate and reduces pressure of an upstream side of the bead, characterized in that the coating head is set such that a slit clearance is in a range from over 50 μm to 500 μm, a length of a downstream side lip is in a range from over 30 μm to 500 μm, and an overbite amount by which the upstream side lip is shorter than the upstream side lip is in a range from over 0 μm to 500 μm, in that a lip clearance between the upstream side lip of the coating head and the substrate is set in a range from over 50 μm to 500 μm, and that a pressure reduction degree of the suction chamber is set in a range from over 0 kPA to 2.0 kPa with respect to atmospheric pressure.

The seventh aspect uses the extrusion type coater for the top layer, and the pressure reduction degree of the suction chamber, the slit clearance, the overbite amount of the upstream side lip, and the lip clearance are set as described above. Thereby, when the top layer is coated and formed on the coloring material receiving layer in the semidry state, the stable bead can be formed, and coating can be conducted, even when the required coating amount and the supply coating amount are the same, and therefore, it is possible to omit the smoothing/metering unit which is normally provided after top layer coating when producing the recording sheet.

In the seventh aspect, an eighth aspect is characterized by further including a smoothing/metering unit, which applies smoothing/metering treatment to the top layer surface, between the coater for the top layer and the second dryer.

The eighth aspect is constructed so that after the coating is conducted so that the supply coating amount is excessive with respect to the required coating amount in the top layer coating, the smoothing/metering treatment is performed with the smoothing/metering unit, and in this case, since the bead is more stabilized than in the case where the required coating amount and the supply coating amount are the same, stable high-speed coating can be conducted.

As described thus far, according to the method and apparatus for producing a recording sheet of the present invention, in the top layer coating on producing the recording sheet provided with the coloring material receiving layer containing inorganic particulates and a water-soluble resin, stable coating can be conducted even when the coating speed is increased (20 m/min or more) in the state in which the excessive amount of the supply coating amount with respect to the required coating amount is zero or extremely small. Thereby, even in the high-speed coating, the scraped amount does not occur at all or can be reduced significantly, and therefore, productivity can be enhanced by reducing the coating solution loss.

### BRIEF DESCRIPTION OF THE DRAWINGS

FIG. 1 is a conceptual view of an entire construction of an apparatus for producing a recording sheet of the present invention, which is the apparatus in which a coloring material receiving layer and a top layer are dried with one dryer;

FIG. 2 is a conceptual view of an entire construction of an apparatus for producing a recording sheet of the present invention, which is the apparatus in which a top layer is dried with a casting drum;

FIG. 3 is an explanatory view explaining an entire construction of an extrusion type coater in the present invention;

FIG. 4 is an explanatory view explaining various conditions such as a lip clearance and the like of the extrusion type coater in the present invention; and

FIG. 5 is an explanatory view explaining a coating angle of a coating head.

### DETAILED DESCRIPTION OF THE PREFERRED EMBODIMENTS

A preferred embodiment of a method and an apparatus for producing a recording sheet of the present invention will be described in detail hereinafter with reference to the accompanying drawings.

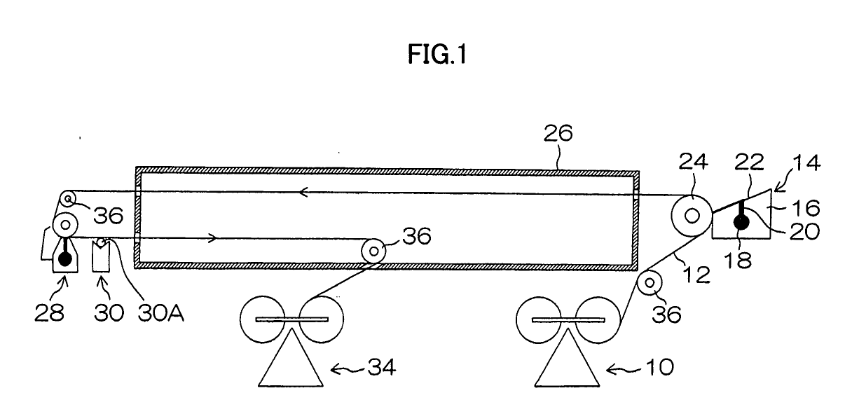

FIG. 1 is a conceptual view showing an entire construction of an apparatus for producing a recording sheet of the present invention.

As shown in FIG. 1, a substrate 12 which is fed out from a feeder 10 is first coated with a coating solution for a coloring material receiving layer as a sublayer, which contains inorganic particulates and a water-soluble resin, with a coater 14 for a coloring material receiving layer. As the substrate 12, WP paper and a resin film of PET or the like can be preferably used, but wood free paper and the like other than them may be used. The substrates with the width of 500 mm to 2000 mm can be preferably used.

FIG. 1 shows the case where the slide coater is used as the coater 14 for a coloring material receiving layer, the coating solution is supplied to a manifold 18 formed inside a coating head 16 of the slide coater, allowed to diffuse and run in a width direction of the substrate 12, thereafter pushed out toward a slide surface 22 via a slit 20 to run down the slide surface 22. The coating solution having run down the slide surface 22 forms a bead in a clearance portion between a tip end portion of the slide surface and the substrate 12 which is engaged and supported by a coating roll 24 and applied onto the substrate 12 via the bead. Thus, a coloring material receiving layer in a coating amount of, for example, about 100 to 300 g/m² is formed on the substrate 12. In FIG. 1, the slide coater is used as the coater 14 for the coloring material receiving layer, but the other coaters such as an extrusion coater, a curtain coater and a bar coater can be also used.

Next, the substrate 12 having a coloring material receiving layer formed thereon travels in a drying zone of a dryer 26, so that the coloring material receiving layer is dried into a semidry state, and is coated with a crosslinking agent coating solution in excess in a wet on wet manner by a coater for a top layer 28 disposed at an outlet side of the dryer 26. Thereby, a top layer is coated on the coloring material receiving layer. In this embodiment, the example of the crosslinking agent layer is described as the top layer, but, for example, the case of coating another coloring material receiving layer, a protection layer or the like may be adopted. The viscosity of the coating solution for the top layer is preferably 10 cP or less, and the required coating amount which is finally coated on the coloring material receiving layer is preferably in the range of 5 to 100 cc/m².

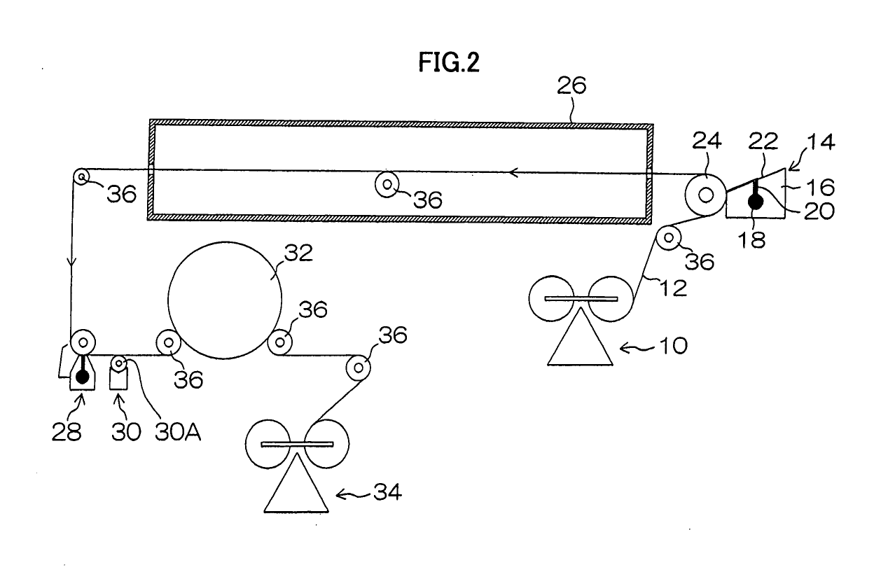

Immediately after the coating of the crosslinking agent coating solution, the top layer is subjected to smoothing/metering treatment with a smoothing/metering unit 30 (FIG. 1 shows the bar type). In this case, in the process of drying the coloring material receiving layer, before the drying speed enters a falling drying rate period, the drying operation is conducted in the air at the drying temperatures ranging from 20 to 180° C., preferably at temperatures ranging from 30 to 150° C. for 0.5 to 5 minutes, and the crosslinking agent coating solution is applied before the drying speed enters the falling drying rate period or when the moisture content (moisture/solid in weight %) of the coloring material receiving layer is in the range of 200 to 600%. The moisture content of the coloring material receiving layer is preferably in the range of 200 to 500%, more preferably in the range of 250 to 450%. Smoothing/metering treatment is preferably conducted by a bar 30A in 30 seconds immediately after the crosslinking agent is applied. Thereby, deterioration of the surface conditions (coating trouble such as lines and unevenness) of the top layer surface caused by bad surface conditions of the coloring material receiving layer as the sublayer, bubble trouble and the like are repaired, and a coated surface of satisfactory conditions and of high glossiness can be formed. The drying operation after the smoothing/metering treatment may be conducted with the dryer 26 in the air at a temperature of about 180° C. When the substrate is permeable like paper, a casting drum 32 may be used as shown in FIG. 2. FIG. 1 shows the case where both the coloring material receiving layer and the top layer are dried with the one dryer 26, but the coloring material receiving layer and the top layer may be dried with separate dryers. The recording sheet thus produced is wound up with a windup unit 34. When the crosslinking agent coating solution is applied, preferably no other coatings are applied on the substrate 12, except an under coat for improving coating adhesion properties, wettability and the like of the substrate 12, or except those other than an under coat, moisture content of which is 10% or less. The reason is that, in coating the top layer, if there exists a coating film having high moisture content other than a sublayer on the substrate 12, the moisture content of the sublayer is significantly affected and the coating for forming a top layer does not go on well. Reference numeral 36 denotes a guide roller for forming a traveling path of the substrate 12.

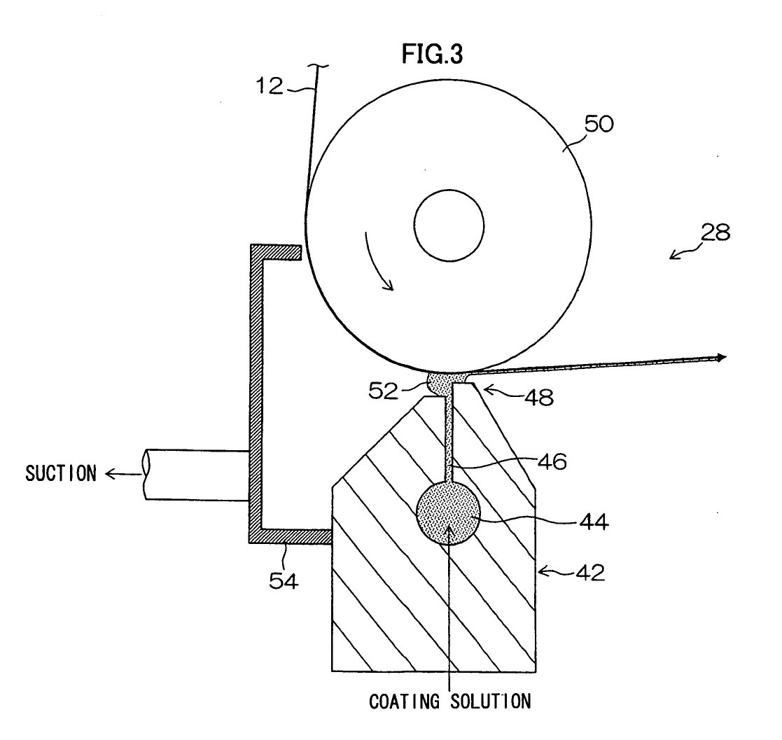

As the coater for the top layer 28 in such a producing apparatus, an extrusion type coater in which the various conditions of the coater are set so as to stably coat the top layer coating solution on the coloring material receiving layer in a semidry state is provided. In the extrusion type coater for the top layer 28, the top layer coating solution is supplied to a manifold 44 of a coating head 42 and allowed to diffuse in the width direction of the substrate, and thereafter, is discharged from a slit tip end 48 through a slit 46 as shown in FIG. 3. The discharged coating solution cross-links the surface of the band-shaped substrate 12 (coated with the coloring material receiving layer in the present invention) which is wound and supported on a backup roller 50 to travel continuously and forms a bead 52 between the slit tip end 48 and the substrate 12, and is coated on the surface of the substrate 12 via the bead 52.

The extrusion type top layer coater 40 is provided with a suction chamber 54 which reduces the pressure of an upstream side of the bead 52 at an upstream side of the coating head 42 seen in the traveling direction of the substrate 12. The pressure reduction degree of the suction chamber 54 is set in the range from over 0 kPa to 2.0 kPa with respect to the atmospheric pressure. The reason is that when the pressure reduction degree increases exceeding 2.0 kPa with respect to the atmospheric pressure, the bead 52 is drawn to the upstream side so much that a line trouble is likely to occur on the film surface of the top layer. Accordingly, the pressure reduction degree of the suction chamber 54 is preferably set at 2.0 kPa or less, and more preferably at 1.0 kPa or less.

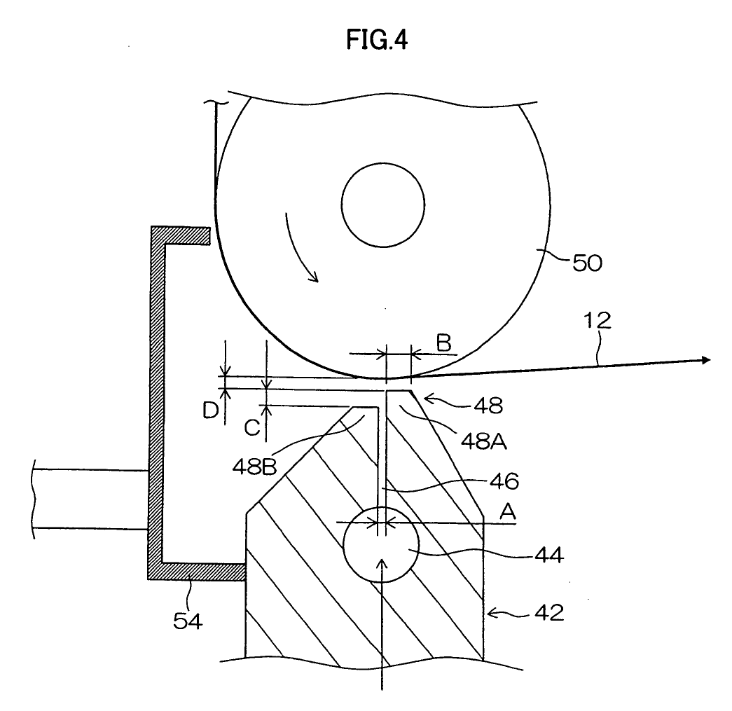

As shown in FIG. 4, in the coating head 42, a slit clearance A is preferably in the range from over 50 μm to 500 μm, more preferably 300 μm or less, particularly preferably 200 cm or less. Thickness B of a downstream side lip 48A in the lip tip end 48 is preferably in the range from over 30 μm to 500 μm, and more preferably 300 μm or less. An overbite amount C of the upstream side lip is preferably in the range from over 0 μm to 500 μm. A lip clearance D between the upstream side lip 48B in the lip tip end 48 and the coloring material receiving layer surface is preferably in the range from over 50 μm to 500 μm, more preferably is 300 μm or less, and particularly preferably is 200 μm or less.

As described above, the respective coating conditions of the pressure reduction degree of the suction chamber 54, the slit clearance A, the overbite amount C of the upstream side lip 48B, and the lip clearance D are set as described above. Thereby, even when the coating speed in the coating of the top layer is increased to 20 m/min or more, for example, the bead 52 can be stabilized without increasing the supply coating amount to be twice as large as the required coating amount or more, and therefore, coating trouble such as lines and unevenness does not occur. Thereby, the scraped amount can be significantly decreased even in the high-speed coating, and therefore, the coating solution loss is reduced to be able to enhance productivity.

Depending on the manner of setting of the above described coating conditions, a stable bead can be formed and coating can be conducted even if the required coating amount and the supply coating amount of the coating solution which form the top layer are the same. Therefore, the smoothing/metering unit 30 is provided in the embodiment of the present invention, but the smoothing/metering unit 30 can be omitted.

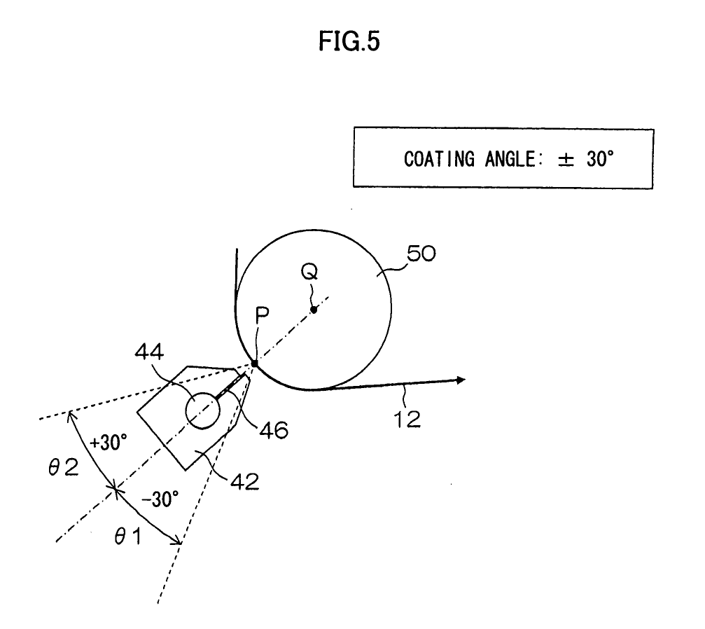

The angle of the coating head 42 relative to the substrate 12 which is traveling may be optional, but it is necessary to keep the bead pressure high by forming the bead 52 of the coating solution discharged from the coating head 42 and to reduce the pressure of the upstream side of the bead 52 in the high bead pressure state with the suction chamber 54. Accordingly, the orientation of the coating head 42 is preferably adjusted so that the coating angle of the coating head 42 with respect to the backup roller 50 is in the range of ±30°. Here, the coating angle is zero degree when the slit 46 of the coating head 42 is oriented to a center Q of the backup roller 50 as shown in FIG. 5. Then, when a coating point of the coating solution to the substrate 12, which is wound and supported on the backup roller 50, from the lip tip end 48 is set as a swing point P, the angle which is formed when the orientation of the slit 46 is swung in the traveling direction of the substrate 12 is expressed as a coating angle θ1 of a plus sign and an angle formed when the slit 46 is swung in the reverse direction is expressed as a coating angle θ2 of a minus sign.

As an example of the inorganic particulates used in the present invention, silica particulates, colloidal silica, calcium silicate, zeolite, kaolinite, halloysite, muscovite, talc, calcium carbonate, calcium sulfate, boehmite and pseudo-boehmite and the like can be cited. In the viewpoint of not reducing transparency, the inorganic particulates preferably have a refractive index in the range of 1.40 to 1.60. Of all the inorganic particulates, silica particulates are particularly preferable. The average diameter of the primary particles of the inorganic particulates is preferably 20 nm or less, more preferably 10 nm or less, and particularly preferably 3 nm or less. The refractive index is preferably about 1.45.

As examples of the water-soluble resins used in the present invention, resins having a hydroxyl group as a hydrophilic structural unit, such as poly vinyl alcohol (PVA), cellulose resins (methyl cellulose (MC), ethyl cellulose (EC), hyddroxyethyl cellulose (HEC), carboxymethyl cellulose (CMC) etc.), chitins and starch; resins having an ether linkage, such as polyethylene oxide (PEO), polypropylene oxide (PPO), polyethylene glycol (PEG) and polyvinyl ether (PVE); and resins having an amide group or amide linkage, such as polyacrylarnide (PAAM) and polyvinylpyrrolidone (PVP) can be cited. Further, resins having a carboxyl group as a dissociative group, such as polyacrylates, maleates, alginates and gelatins; resins having a sulfonic acid group, such as polystyrene sulfonate; and resins having an amino group, an imino group, a tertiary amine or a quaternary ammonium salt, such as polyallyl-amine (PAA), polyethylene imine (PEI), epoxidized polyamide (EPA), polyvinyl pyridine and gelatins can be cited.

As examples of the crosslinking agents used in the present invention, boric acid, borates (for example, orthoborates, InBO₃, ScBO₃, YBO₃, LaBO₃, Mg₃(BO₃)₂, Co₃(BO₃)₂), diborates (for example, Mg₂B₂O₅, Co₂B₂O₅), methaborates (for example, LiBO₂, Ca(BO₂)₂, NaBO₂, KBO₂), tetraborates (for example, Na₂B₄O₇.10H₂O), pentaborates (for example, KB₅O₈, 4H₂O, Ca₂B₆O₁₁.7H₂O, CsB₅O₅), glyoxal, melamine-formaldehyde (for example, methylolmelanine and alkylated methylolmelamine), methylolurea, resol resin, polyisocyanate and the like can be cited. Of all the crosslinking agents above, boric acid and borates are particularly preferable.

The smoothing/metering units for conducting smoothing/metering treatment include, for example, a bar type, an air knife type and a blade type smoothing/metering units.

The bar type smoothing/metering unit is such that a round bar is allowed to be in contact with a coated surface formed on a substrate in a state in which the axial direction of the round bar is disposed in a width direction of the traveling substrate. The bar is preferably round and its diameter ranges from 2 mm to 200 mm, more preferably from 5 mm to 50 mm. The bar is allowed to rotate at a circumference speed the same as the traveling speed of the substrate or within the traveling speed of the substrate ±50% both in the same direction as the travel of the substrate and in the opposite direction to the same. In this case, the lap angle (θ) of the substrate to the bar is suitably within the range of 0° to 30°. According to a required coating amount, the bar has grooves formed between the wires by winding a wire around it, or has grooves directly cut in itself, so that metering is performed when the bar and the coated surface come in contact with each other because the bar traps the excessive coating solution in the grooves.

The air knife type smoothing/metering unit is such that with the longitudinal direction of the slot-shaped air nozzle which blows off air in a knife form disposed in the width direction of the traveling substrate, the air in the knife form from the air nozzle is shot to the coated surface, and thereby the surface layer of the coating is scraped while the coated surface is leveled. The velocity of the air shot from the air nozzle is in the range of 10 to 150 m/sec, and the pressure of the air is in the range of 0.01 to 10 kg/cm², particularly preferably in the range of 0.5 to 5 kg/cm². The distance to the coated surface of the topmost layer from the tip end of the air nozzle is set in the range of 1 to 30 mm, and the angle formed by the air nozzle and the coated surface is preferably in the range of 1° to 50°.

The blade type smoothing/metering unit is such that with the width direction of a blade disposed in the width direction of the substrate, the blade is brought into contact with the coated surface formed on the substrate, and thereby the coating surface layer portion is scraped while the coated surface is leveled. The blade used for this is made of flexible resin material and the pushing pressure of the blade against the coated surface is preferably in the range of 0.01 to 10 kg/cm², and especially preferably in the range of 0.1 to 5 kg/cm².

However, more preferably, the above conditions in the bar type, the air knife type, and the blade type smoothing/metering units are adjusted in the range of the above described conditions according to: 1) the required coating amount, 2) the wettability of another coloring material receiving layer as a top layer, different from the coloring material receiving layer or the over coat layer, 3) the cured conditions of the coloring material receiving layer (sublayer) by the crosslinking agent (top layer) when the top layer is a crosslinking agent layer, 4) the composition and the physical properties of the coating solution of each layer of the multiple coatings, 5) the elapsed time from the instance of coating and forming the topmost layer to the smoothing/metering treatment, and the like.

### EXAMPLE

Production of the recording sheet was conducted as follows.

A coloring material receiving layer containing inorganic particulates and a water-soluble resin of the composition shown in Table 1 was coated on the substrate 12 in a coating amount of 100 g/m² with the width of 1.5 m with the slide coater 14. As for preparation of the coating solution for the coloring material receiving layer, the anhydrous silica particulates in Table 1 were added to ion-exchanged water (73.3 parts by weight) and dispersed with a high-speed rotating wet colloid mill (Cleamix, manufactured by M Technique Co., Ltd.) under the condition of 10000 rpm for 20 minutes. Then, polyvinyl alcohol solution (prepared by dissolving in the rest of ion-exchanged water that is 62.7 parts by weight) was added to the above solution and dispersed under the same conditions as above so as to prepare the coating solution for forming the coloring material receiving layer.

Next, the coloring material receiving layer was subjected to drying until it is in the semidry state in the drying zone of a dryer 26 in the air at dry-bulb temperatures ranging from 30 to 80° C. and at a dew-point temperature of 0° C., so as to form a porous layer void percentage of which was 60%.

After the drying, a top layer having the composition shown in Table 2 was coated on the coloring material receiving layer in the semidry state in a supply coating amount of about 60 cc/m² which is larger than the required coating amount by 10 cc with the extrusion coater 28. Three seconds after the coating of the top layer, the top layer was subjected to smoothing/metering treatment with the bar type smoothing/metering unit 30 provided with a bar with a diameter of 25 mm, then subjected to drying with the dryer 26 again to produce a recording sheet. As for preparation of the coating solution for the top layer, polyvinyl alcohol in Table 2 was added to ion-exchanged water, and dispersed similarly to the case of the coloring material receiving layer by using the high-speed rotating colloid mill (Cleamix, manufactured by M Technique Co., Ltd.).

TABLE 1

| Composition of coloring material receiving layer | Compounding Ratio |
|---|---|
| (1) Anhydrous silica particulates | 10 parts by weight |
| (Aerosil 300, manufactured by Japan Aerosil Co., | |
| Ltd.) | |
| Average diameter of primary particles: 7 nm | |
| Silanol group on surface: 2 to 3/nm² | |
| Refractive index: 1.45 | |
| (2) Polyvinyl alcohol | 3.3 parts by weight |
| (PVA 440, manufactured by Kuraray Co., Ltd.) | |
| Degree of saponification: 81.8% | |
| Degree of polymerization: 4000 | |
| (3) Ion-exchanged water | 136.0 parts by weight |

(Notes)
All the numeric values given in parts by weight representing the compounding ratio express the solids content or the nonvolatile content.

TABLE 2

| Composition of top layer | Compounding ratio |
|---|---|
| (1) Polyvinyl alcohol | 5 parts by weight |
| (PVA 440, manufactured by Kuraray Co., Ltd.) | |
| Degree of saponification: 81.8% | |
| Degree of polymerization: 4000 | |
| (2) Ion-exchanged water | 95 parts by weight |

(Notes)
All the numeral values given in parts by weight representing compounding ratio express the solids content or the nonvolatile content.

Then, the tests were made to determine the relationship between the required coating amount and the supply coating amount, to what extent the coating speed could be increased, and the like when the extrusion type coater for the top layer was set under the following conditions and the top layer coating is performed.

### Example 1

Pressure reduction degree of the suction chamber 54: 0.5 kPa with respect to atmospheric pressure
Slit clearance A: two conditions of 300 μm and 100 μm
Thickness of the lip tip end: upstream side lip 1 mm, downstream side lip B 100 μm
Overbite amount C of upstream side lip: 100 μm
Lip clearance D: two conditions of 300 μm and 100 μm
Coating speed: increased to 20, 30, 40, 50, 60, 70, 80, 90 and 100 m/min.

As the result, under the conditions that the slit clearance A was 300 μm and the lip clearance D was 300 μm, favorable coating without lines and unevenness (coating thickness distribution) on the film surface of the top layer was able to be performed and the surface conditions after the smoothing/metering treatment were extremely favorable until the coating speed reached 50 m/min. When the test was conducted next by narrowing the slit clearance A to 100 μm from 300 μm, and by narrowing the lip clearance D to 100 μm from 300 μm, the stable coating was able to performed even when the supply coating amount was made the same as the required coating amount (50 cc/m²), and the favorable surface conditions were able to be obtained without conducting the smoothing/metering treatment.

When the coating speed was increased to 70 m/min from 50 m/min under the conditions that the slit clearance A was 300 μm and the lip clearance was 300 μm, light lines and unevenness occurred on the film surface of the top layer, but the lines and unevenness were eliminated by conducting the smoothing/metering treatment. When the coating speed was further increased from 70 m/min, the bead 52 easily breaks at the point of time when the coating speed exceeded 80 m/min, and therefore, the slit clearance A was narrowed to 100 μm from 300 μm. Then, breaking of the bead 52 was resolved, and coating can be conducted to form the favorable surface conditions without lines and unevenness on the film surface of the top layer.

### Comparative Example 1

Comparative example 1 was carried out with the suction chamber removed from the extrusion coater of Example 1. Comparative example 1 was the same as in Example 1 in the other respects. In Example 1, the two conditions of 300 μm and 100 μm were set for the lip clearance D, but in Comparative example 1, the three conditions of 300 μm, 200 μm and 100 μm were set for the lip clearance D. As for the coating speed, coating was conducted under the four conditions of 10, 20, 30 and 40 m/min. The required coating amount was 50 cc/m², which was the same as in Example 1, but the supply coating amount with respect to the required coating amount was increased to 1.5 times to twice as large as the required coating amount with increase in the coating speed.

As a result, under the conditions that the slit clearance A was 300 μm and the lip clearance D was 300 μm, stable coating was able to be conducted when the supply coating amount was made 1.5 times as large as the required coating amount when the coating speed was 10 m/min and 20 m/min, and the favorable surface conditions were able to be obtained by the smoothing/metering treatment. Next, when the coating speed was made higher to 30 m/min from 20 m/min, the stable coating was able to be conducted only by increasing the supply coating amount to twice as large as the required coating amount and by narrowing the lip clearance D to 200 μm from 300 μm. However, the coating thickness of the end portion (ear portion) in the width direction of the substrate of the top layer tends to be as large as about 150 to 200% of the coating thickness of the central portion, and swelling like a foreign matter of 200 to 300 μm sometimes occurs to the central portion. Therefore, when the lip clearance D is narrowed to 100 μm from 300 μm in the state in which the supply coating amount is increased to be twice as large as the required coating amount, the risk of the lip tip end 48 coming into contact with the coloring material receiving layer becomes high. In fact, when in the test, the coloring material receiving layer was damaged due to thick coating of the ear portion and once it was damaged, the initial damage caused to increase the damage successively, and there was nothing to do but stop the production. It has been found out that when the supply coating amount is increased to be twice as large as the required coating amount, a large amount of coating solution has to be scraped off, and in order to scrape a large amount of coating solution, the smoothing/metering treatment unit 30 has to be firmly pressed against the film surface of the top layer, which is likely to cause a damage to the top layer.

### Comparative Example 2

Comparative example 2 conducted the top layer coating with the bar coater instead of the extrusion coater in Example 1. As the bar of the bar coater, the wire bar with the wire wound around the core metal of the diameter of 10 mm or 20 mm, and the engraved bar with engraving performed in the bar surface of the diameter of 10 mm or 20 mm were used.

Normal rotation in which the rotating direction of the bar was the same direction as the traveling direction of the substrate and the reverse rotation in which the rotating direction of the bar was the reverse direction were both conducted under the five conditions of the rotational speed of the bar, which were 0.5 times, 1.0 time, 1.5 times, 2.0 times and 3.0 times as high as the coating speed.

The tests were made with the clearances between the bar and the coloring material receiving layer of 2 mm, 1 mm, 300 μm, 200 μm and 100 μm in this order. The tests were made under the four conditions of the coating speed, which were 10, 20, 30 and 40 m/min.

As a result, in both cases of the wire bar and the engraved bar, stable coating was able to be conducted anyway until the coating speed reaches 20 m/min by narrowing the clearance between the bar and the coloring material receiving layer to 300 μm, by increasing the bar rotational speed to 1.5 times as high as the substrate speed, and by increasing the supply coating amount to be 1.5 times as large as the required coating amount. However, when the coating speed was increased to 20 m/min, the bead was not stabilized even by narrowing the clearance between the bar and the coloring material receiving layer to 100 μm, and thus, lack of solution occurred. Thus, the rotational speed was increased to 2.0 times as high as the substrate speed, and thereby, the bead was finally stabilized.

When the coating speed was further increased to 40 m/min, in order to stabilize the bead, the rotational speed of the bar had to be further increased from the rotational speed twice as high as the substrate speed, and scattering of the coating solution from the bar end portion increased and the production had to be stopped.

### Comparative Example 3

Comparative example 3 was such that coating of the top layer was conducted with the curtain coater instead of the extrusion coater in Example 1.

The coating was performed under the three conditions of the curtain film height (falling distance of the coating solution from the slide surface tip end to the coloring material receiving layer), which were 1 cm, 10 cm and 100 cm. The coating was performed under the four conditions of the supply coating amount, which were 1.5 times, 2.0 times, 3.0 times and 5.0 times as large as the required coating amount. The coating was performed under the three conditions of the coating speed, which were 20, 40 and 100 m/min.

As a result, in order to keep the curtain film stable, the film flow rate of 1 cc/cm/sec or more is desirable, and in order to cause the film flow rate to correspond to that film flow rate, the coating amount to be applied is about 330 cc/m² in the case of the coating speed of 20 m/min, about 165 cc/m² in the case of the coating speed of 40 m/min, and is finally decreased to about 66 cc/m² in the case of the coating speed of 100 m/min. At the coating speed of 20 m/min, the coating amount was so large that it actually caused the problem of the coating solution running down from the substrate before being scraped off in the smoothing/metering treatment. In the case of the coating speed of 40 m/min, the coating solution did not run down from the substrate, but the same problem as in the above described Comparative examples 1 and 2 occurred. Further, in the case of the coating speed of 100 m/min, the curtain film was drawn by the entrained wind occurring due to the travel of the substrate, and even when the curtain film height was made 100 cm, air was sometimes entrained by the bead. When the curtain film height was made higher than this, the liquid pressure of the dropped curtain film caused dents and projections to the coloring material receiving layer in the semidry state as the sublayer. Trials were made so that the curtain film might not be drawn in the traveling direction of the substrate by the entrained wind occurring due to the travel of the substrate by providing the suction chamber at the upstream side of the curtain film seen in the traveling direction of the substrate and by attracting the upstream side surface of the curtain film, but the suction chamber attracted the substrate and the substrate and the suction chamber came into contact with each other.

What is claimed is:

1. A method for producing a recording sheet including the steps of coating and forming a coloring material receiving layer containing inorganic particulates and a water-soluble resin on a band-shaped substrate which is wound and supported on a backup roller and continuously travels, and thereafter, coating and forming a top layer on the coloring material receiving layer in a semidry state, comprising:
coating the top layer by an extrusion type coater which coats a coating solution to the surface of the substrate via a bead which is formed between the lip tip end and the substrate with cross-linking the coating solution discharged from a lip tip end of a coating head the surface of the substrate, in a state of pressure of an upstream side of the bead reduced so that a pressure reduction degree with respect to atmospheric pressure is in a range from over 0 kPa to 2.0 kPa by providing a suction chamber at an upstream side of the coating head seen in a traveling direction of the substrate.

2. The method for producing a recording sheet according to claim 1,
wherein a slit clearance of the coating head is set in a range from over 50 μm to 500 μm, and a thickness of a downstream side lip seen in the traveling direction of the substrate is set in a range from over 30 μm to 500 μm.

3. The method for producing a recording sheet according to claim 1,
wherein a structure of the lip tip end of the coating head is made an overbite structure with an upstream side lip length smaller than a downstream side lip length, and an amount of the overbite is set in a range from over 0 μm to 500 μm.

4. The method for producing a recording sheet according to claim 1,
wherein a lip clearance between the upstream side lip and a surface of the coloring material receiving layer coated on the substrate is set in a range from over 50 μm to 500 μm.

5. The method for producing a recording sheet according to claim 1,
wherein smoothing of a surface of the top layer film and adjustment of a coating amount of the top layer are performed by conducting smoothing/metering treatment within 30 seconds after the top layer is coated and formed.

6. The method for producing a recording sheet according to claim 1,
wherein the top layer is a crosslinking agent layer for hardening the coloring material receiving layer.

7. The method for producing a recording sheet according to claim 2,
wherein a structure of the lip tip end of the coating head is made an overbite structure with an upstream side lip length smaller than a downstream side lip length, and an amount of the overbite is set in a range from over 0 μm to 500 μm.

8. The method for producing a recording sheet according to claim 2,
wherein a lip clearance between the upstream side lip and a surface of the coloring material receiving layer coated on the substrate is set in a range from over 50 μm to 500 μm.

9. The method for producing a recording sheet according to claim 2,
wherein smoothing of a surface of the top layer film and adjustment of a coating amount of the top layer are performed by conducting smoothing/metering treatment within 30 seconds after the top layer is coated and formed.

10. The method for producing a recording sheet according to claim 3,
wherein a lip clearance between the upstream side lip and a surface of the coloring material receiving layer coated on the substrate is set in a range from over 50 μm to 500 μm.

11. The method for producing a recording sheet according to claim 3,
wherein smoothing of a surface of the top layer film and adjustment of a coating amount of the top layer are performed by conducting smoothing/metering treatment within 30 seconds after the top layer is coated and formed.

12. The method for producing a recording sheet according to claim 4,
wherein smoothing of a surface of the top layer film and adjustment of a coating amount of the top layer are performed by conducting smoothing/metering treatment within 30 seconds after the top layer is coated and formed.

13. The method for producing a recording sheet according to claim 7,
wherein a lip clearance between the upstream side lip and a surface of the coloring material receiving layer coated on the substrate is set in a range from over 50 μm to 500 μm.

14. The method for producing a recording sheet according to claim 7,
wherein smoothing of a surface of the top layer film and adjustment of a coating amount of the top layer are performed by conducting smoothing/metering treatment within 30 seconds after the top layer is coated and formed.

15. The method for producing a recording sheet according to claim 10,
wherein smoothing of a surface of the top layer film and adjustment of a coating amount of the top layer are performed by conducting smoothing/metering treatment within 30 seconds after the top layer is coated and formed.

16. The method for producing a recording sheet according to claim 10,
wherein smoothing of a surface of the top layer film and adjustment of a coating amount of the top layer are performed by conducting smoothing/metering treatment within 30 seconds after the top layer is coated and formed.

17. The method for producing a recording sheet according to claim 13,
wherein smoothing of a surface of the top layer film and adjustment of a coating amount of the top layer are performed by conducting smoothing/metering treatment within 30 seconds after the top layer is coated and formed.

18. An apparatus for producing a recording sheet for coating and forming a top layer on a coloring material receiving layer in a semidry state after coating and forming the coloring material receiving layer containing inorganic particulates and a water-soluble resin, on a band-shaped substrate which continuously travels, comprising:
a coater for a coloring material receiving layer which coats and forms the coloring material receiving layer on the substrate;
a first dryer which dries the coloring material receiving layer to the semidry state;
an extrusion type coater for a top layer which coats and forms the top layer on the coloring material receiving layer in the semidry state comprising,
a coating head which coats a coating solution for the top layer discharged from a lip tip end onto the substrate via a bead,
a backup roller which is disposed to be opposed to the coating head and supports the substrate, and
a suction chamber which is provided at an upstream side of the coating head seen in a traveling direction of the substrate and reduces pressure of an upstream side of the bead,
wherein the coating head is set such that a slit clearance is in a range from over 50 μm to 500 μm, a length of a downstream side lip is in a range from over 30 μm to 500 μm, and an overbite amount by which the upstream side lip is shorter than the downstream side lip is in a range from over 0 μm to 500 μm,
wherein a lip clearance between the upstream side lip of the coating head and the substrate is set in a range from over 50 μm to 500 μm, and
wherein a pressure reduction degree of the suction chamber is set in a range from over 0 kPA to 2.0 kPa with respect to atmospheric pressure; and
a second dryer which dries the top layer after the top layer is coated.

19. The apparatus for producing a recording sheet according to claim 18, further comprising a smoothing/metering unit, which applies smoothing/metering treatment to the top layer surface, between the coater for the top layer and the second dryer.
